(19) United States
(12) Patent Application Publication
(10) Pub. No.: US 2013/0175863 A1
(43) Pub. Date: Jul. 11, 2013

(54) Power Sub-grid Including Power Generated From Alternative Sources

(71) Applicant: Yang Pan, Shanghai (CN)

(72) Inventor: Yang Pan, Shanghai (CN)

(21) Appl. No.: 13/345,712

(22) Filed: Jan. 8, 2012

(51) Int. Cl. H02J 1/00; H02J 3/00

(52) U.S. Cl. 307/26

(57) ABSTRACT

A power sub-grid for distributing both AC and DC powers is disclosed. A controller selects one of the operation modes for the sub-grid. The operation modes include 1) distributing AC power only; 2) distributing DC power only; and 3) distributing both AC and DC powers. The controller selects the operation mode based upon available DC power generated from alternative sources coupled to the sub-grid and required power for AC and DC electrical appliances in all consumption units. An inter sub-grid power bridge may be used to deliver surplus DC power to another sub-grid.

### CROSS-REFERENCE TO RELATED APPLICATIONS

Not applicable

### BACKGROUND

1. Field of Invention

This invention relates to a power distribution system, specifically to a power sub-grid including alternative power generation sources.

2. Description of Prior Art

In recent years, concerns have been raised that high demand for electricity taxing the capacity of existing electricity generating plants. Furthermore, concerns regarding the availability and environmental safety of fossil and nuclear fuel are being raised. As a result of the above factors, the price of electricity has been on a path of steady increasing. It has become increasing common to seek for alternative power sources. One such power source is the sun. Solar panels have been available for many years for the purpose of converting the energy from sunlight into electricity. The collected energy is in a form of DC (Direct Current) electricity. Another such power source is wind turbines. The electrical power generated from wind turbines is in a form of AC (Alternate Current). However, the generated AC power cannot be distributed by a conventional power grid or be consumed directly by electrical appliances because the generated AC power is not having a right frequency. The AC power will need to be converted into DC power at a first step and, subsequently, be converted to AC power in the frequency of the commercial AC power distributed by a power grid or a sub-grid. Yet another such energy source is fuel cells that generate DC power.

DC powers generated from the alternative power sources have to be converted into AC power before they can be distributed through the power grids. Converting DC powers into AC powers not only increases cost but also causes unnecessary power loss during the conversion. There is a group of electrical appliances, such as, for example, refrigerators and air-conditioners that consume directly AC power. There is another group of electrical appliances, such as, for example, a computer and a lighting emitting diode lighting system that consume DC power.

Therefore, it is desirable to have a power grid or sub-grid that distributes both AC power generated from distant power plants and DC powers generated from various alternative power sources. The DC power distributed by the power grid can be consumed by DC electrical appliances in consumption units directly.

### SUMMARY OF THE INVENTION

It is therefore an object of the present invention to provide a power sub-grid structure that can select one of the following operation modes: 1) distributing AC only; 2) distributing DC power only; and 3) distributing both AC and DC powers.

It is another object of the present invention to enable consumption units coupled to the sub-grid to consume DC power generated from the alternative power sources with a higher priority.

It is yet another object of the present invention to provide a system and method that deploys directly surplus DC power generated from the alternative power sources from one sub-grid to another sub-grid through an inter sub-grid power bridge that is controlled by a controller of the sub-grid.

An exemplary power distribution system comprises an AC power grid and at least one AC/DC sub-grid. The AC/DC sub-grid comprises three operation modes including: 1) distributing AC power only; 2) distributing DC power only; and 3) distributing both AC and DC powers. The operation mode is selectable by a sub-grid controller. The sub-grid is connected to the AC power grid through a switch controlled by the controller. The controller further comprises a data processor, a demand detector and supply detector. The supply detector determines DC powers generated from alternative power sources coupled to the sub-grid. The demand detector determines power required for operations of all consumption units in the sub-grid. The controller selects one of the operation modes based upon supply and demand situation.

The AC/DC sub-grid is connectable to another sub-grid through an inter sub-grid power bridge that is a switch controllable by the sub-grid controller. Surplus DC power generated from the alternative power sources may be transferred to another sub-grid through the bridge. The surplus DC power may also be injected to the AC power grid after it is converted into AC form or be stored in a grid storage unit.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 is a schematic diagram of an exemplary power distribution system including an AC power grid and at least one exemplary AC/DC power sub-grid.

FIG. 2 is schematic diagram of a sub-grid controller.

FIG. 3 is a schematic diagram illustrating that surplus DC power may be distributed from one sub-grid to another sub-grid through an inter sub-grid power bridge.

FIG. 4 is a schematic diagram illustrating an exemplary power consumption unit coupled to the sub-grid.

FIG. 5 is a schematic diagram illustrating functional blocks of a unit controller for the consumption unit.

FIG. 6 is a flowchart illustrating a process of selecting operation mode of the sub-grid.

FIG. 7 is a flowchart illustrating a process of deploying surplus DC power generated from the alternative power sources.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

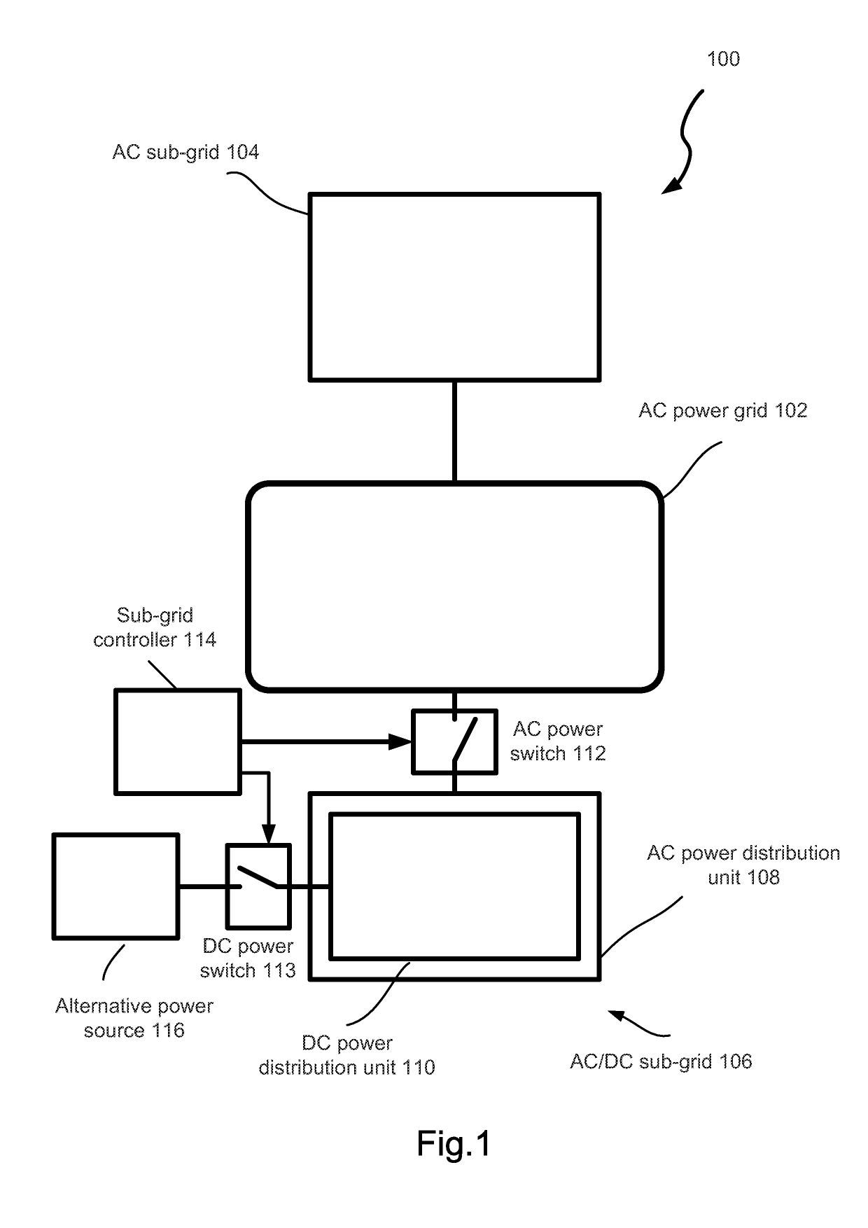

FIG. 1 is a schematic diagram of an exemplary power distribution system including an AC power grid and at least one exemplary AC/DC sub-grid. Exemplary power distribution system 100 comprises an AC power grid 102. A conventional AC sub-grid 104 is connected to AC power grid 102. AC/DC sub-grid 106 is coupled to AC power grid 102. Sub-grid 106 further includes an AC power distribution unit 108. AC power distribution unit 108 receives AC power from AC power grid 102 and distributes the AC power to consumption units in sub-grid 106. AC power distribution unit 108 may include transmission cables. Sub-grid 106 further comprises a DC power distribution unit 110. DC power distribution unit 110 distributes DC power to the consumption units.

In one aspect, AC power distribution unit 108 and DC power distribution unit 110 may comprise different sets of transmission lines. In another aspect, AC power distribution unit 108 and DC power distribution unit 110 may share some or all transmission lines. 108 and 110 may further include other power processing units as known in the art.

Sub-grid 106 is connectable to AC power grid 102 through an AC power switch 112 that is controlled by a sub-grid controller 114. An alternative power source 116 may be coupled through a DC power switch 113 to AC/DC sub-grid 106. Switch 113 is controlled by sub-controller 114. More alternative power sources may be connected to sub-grid 106. Alternative power source 116 may include but is not limited to a solar power system, a wind turbine and a fuel cell system. If the wind turbine is used, generated AC power will be converted into DC form.

Sub-grid controller 114 may select one of the three operation modes for sub-grid 106.

Operation mode 1: If alternative power source 116 generates negligible DC power, controller 114 selects sub-grid 106 to distribute AC power received from AC power grid 102. Switch 112 will be switched on and switch 113 will be switched off.

Operation mode 2: If alternative power source 116 generates sufficient DC power for powering all consumption units coupled to sub-grid 106, controller 114 switches off switch 112 and switches on switch 113. All consumption units are powered by DC power generated from the alternative power source.

Operation mode 3: If DC power generated from alternative power source 116 is significant but is insufficient to power all consumption units coupled to sub-grid 106, controller 114 switches on switch 112 and switch 113. Both AC and DC powers are distributed to the consumption units through AC power distribution unit 108 and DC power distribution unit 110, respectively. Each of the consumption units includes a unit controller. All unit controllers operate with sub-grid controller 114 to ensure that DC power generated from alternative power source 116 is consumed with a higher priority by the consumption units.

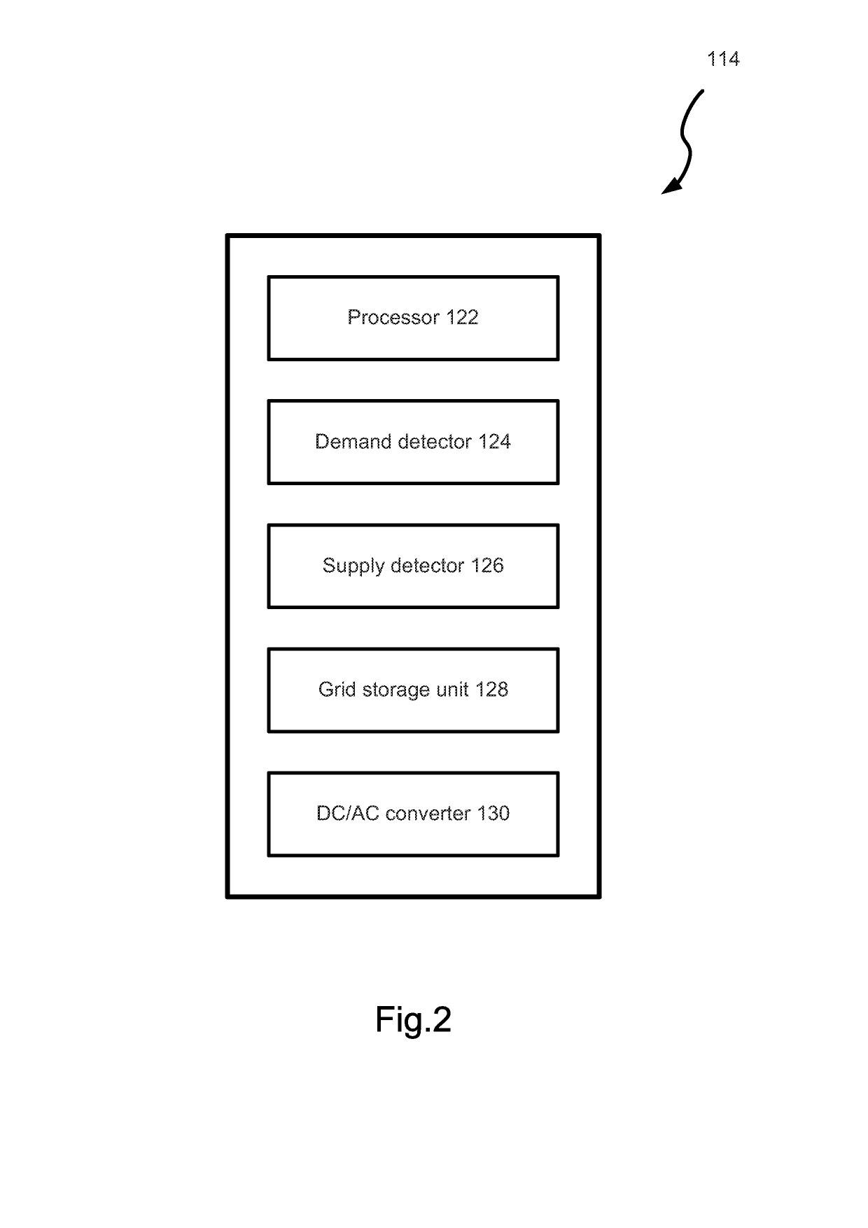

FIG. 2 is schematic diagram of an exemplary sub-grid controller. Sub-grid controller 114 includes a data processor 122 pertaining to controlling operations of the controller. Controller 114 further includes a demand detector 124 and a supply detector 126. Demand detector 124 determines power supply requirement from all consumption units in sub-grid 106. Supply detector 126 determines total DC powers generated from all alternative power sources connected to sub-grid 106. The alternative power sources include but are limited to solar power systems, wind turbines, fuel cell systems, and power storage devices including batteries. The DC power may further include DC power transferred from other sub-grids. Controller 114 further includes a grid storage unit for storing surplus DC power. It should be noted that inclusion of grid storage unit 128 is optional and should not limited the scope of the present inventive concept. Controller 114 further includes a DC/AC converter pertaining to converting surplus DC power generated from the alternative power sources to AC power and injecting the AC power to AC power grid 102. It should also be noted that inclusion of DC/AC converter 130 is optional and is not essential for operations of controller 114 and therefore should not limit the scope of the present invention. In another aspect, grid storage unit 128 and DC/AC converter 130 may be separated apparatus coupled to controller 114.

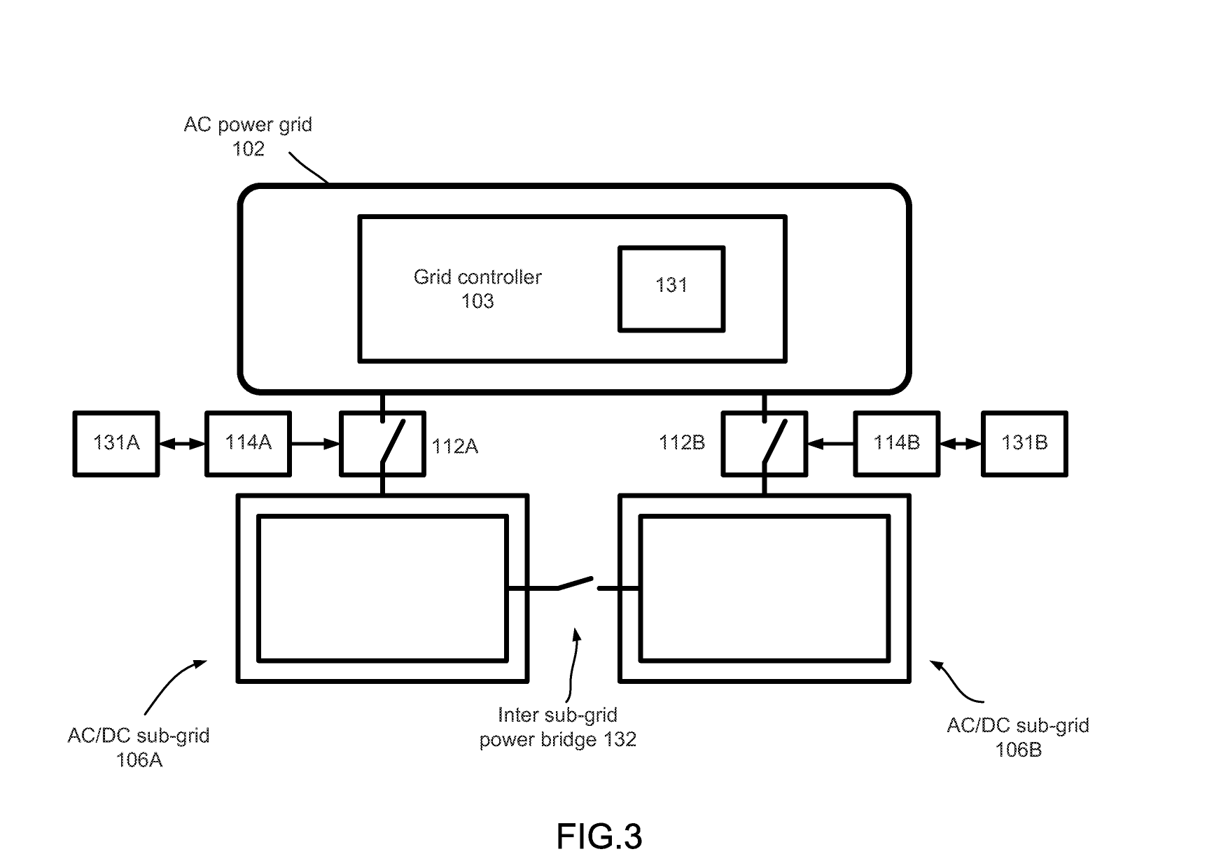

FIG. 3 is a schematic diagram illustrating that surplus DC power may be distributed from one sub-grid (106A) to another sub-grid (106B). An inter sub-grid power bridge 132 connects DC power distribution unit 110A with DC power distribution unit 110B. Inter sub-grid power bridge 132 is a switch controlled by sub-grid controller 114A and/or sub-grid controller 114B. 114A may be connected to a communication unit 131A. 114B may be connected to a communication unit 131B. When surplus DC power is available in sub-grid 106A, 114A may send a request to transfer the surplus DC power to sub-grid 106B. The request may be sent through communication units 131A and 131B. In one aspect, upon receiving the request, sub-grid controller 114B may negotiate a deal with 114A for receiving the surplus DC power. If an agreement is reached between 114A and 114B, inter sub-grid power bridge 132 connects DC power distribution unit 110A to DC distribution unit 110B. The surplus DC power is transferred from 106A to 106B.

In another aspect, AC power grid 102 may include a grid controller 103 to facilitate the surplus DC power transfer among AC/DC sub-grids. Grid controller 103 may include a communication unit 131 for communicating with 131A and 131B.

In yet another aspect, surplus DC power may be transferred among the sub-grids in accordance with previously agreed deals among sub-grids.

In yet another aspect, surplus DC power may be auctioned by one or more sub-grids through sub-grid controllers and a communication network.

The communication units may be nodes of a wireless communication network. The communication units may also be nodes of a wired communication network. The communication network may be the Internet or a public telephone network. The communication network may comprise ad hoc communication network that includes but is not limited to Wi-Fi, Bluetooth, NFC and ZigBee. The communication network may be implemented based upon power transmission lines. The implementations of communication network are known to one skilled in the art.

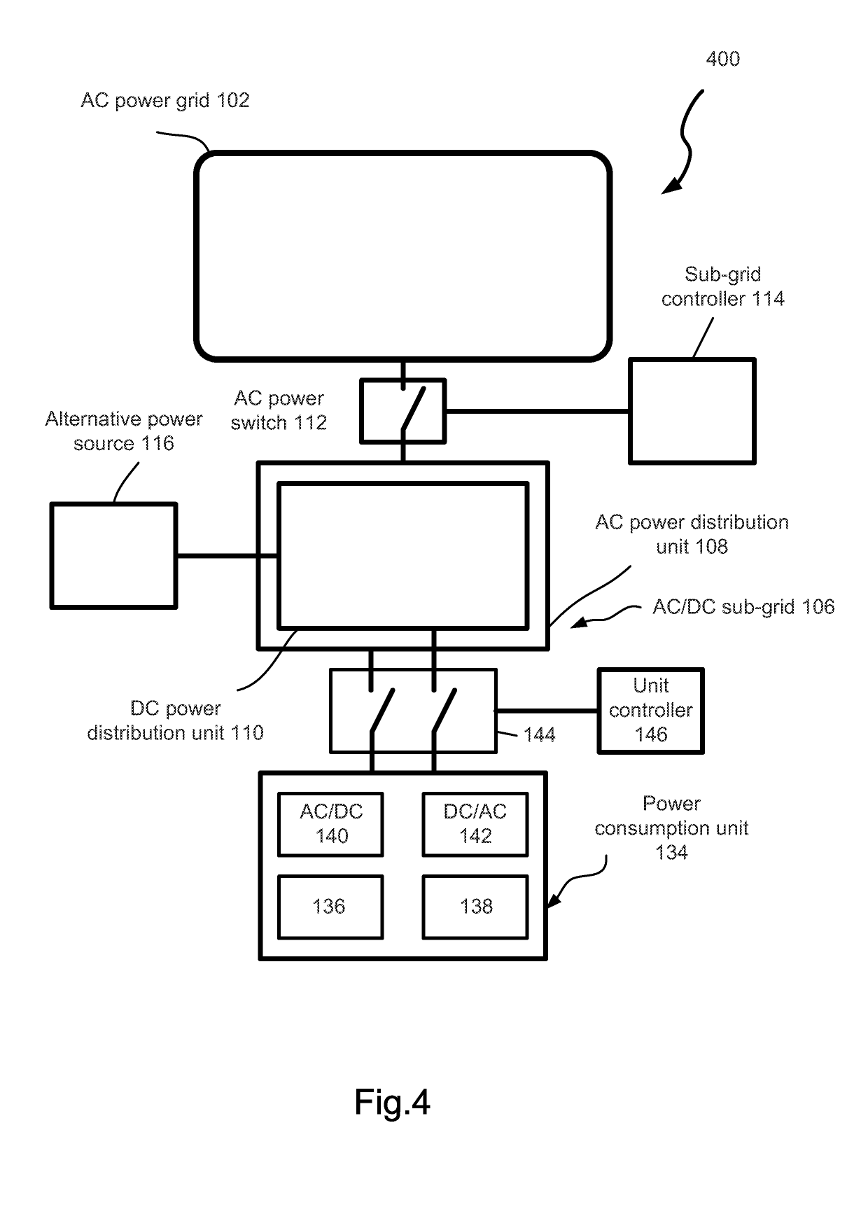

FIG. 4 is a schematic diagram illustrating an exemplary consumption unit 134 coupled to the sub-grid 106. Sub-grid 106 is connected to AC power grid 102 through an AC power switch 112 that is controlled by sub-grid controller 114. Power consumption unit 134 is coupled to sub-grid 106 through a switch 144. Switch 144 is controlled by a unit controller 146. Power consumption unit 134 may be a residential unit in an exemplary case. Power consumption unit 134 further comprises a first group of electrical appliances (136) that receive DC power and a second group of electrical appliances (138) that receive AC power. Consumption unit 134 further includes AC/DC converter 140 and DC/AC converter 142. Consumption unit 134 is connectable to AC distribution unit 108 and/or to DC distribution unit 110. Unit controller 146 optimizes power consumption of power consumption unit 134 by ensuring consuming DC power from DC power distribution unit 110 as a priority over AC power from AC power distribution unit 108.

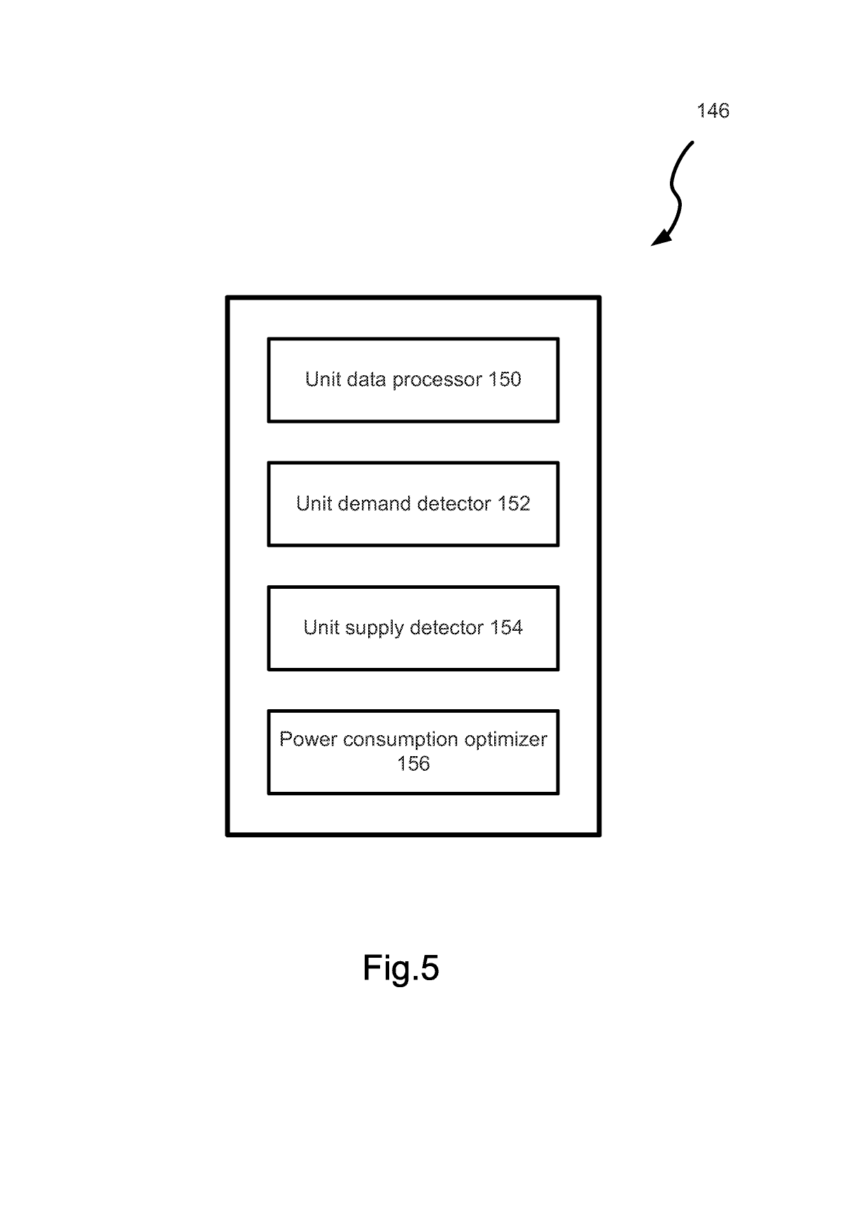

FIG. 5 is a schematic diagram illustrating functional blocks of an exemplary unit controller 146 for the consumption unit 134. The unit controller 146 includes a data processor 150 pertaining to controlling operations of the consumption unit with regard to power consumptions. Data processor 150 may include a microprocessor or a microcontroller. Unit controller 146 further includes a unit demand detector 152 and a unit supply detector 154. Unit demand detector 152 determines power supply demand from all appliances in the unit. Unit supply detector 154 determines available DC power supplied from DC power distribution unit 110. When DC power generated from the alternative power sources is insufficient to power all DC appliances 138 in all power consumption units 134, sub-grid controller 114 allocates DC power to the consumption units in accordance with predetermine rules. The predetermined rules may include but are not limited to minimizing DC power during power transmission and maximizing revenue generated from sub-grid 106. If the consumption unit receives both DC and AC powers, a power consumption optimizer 156 in unit controller 146 is used to optimize power consumption in the unit by consuming received DC power as a priority.

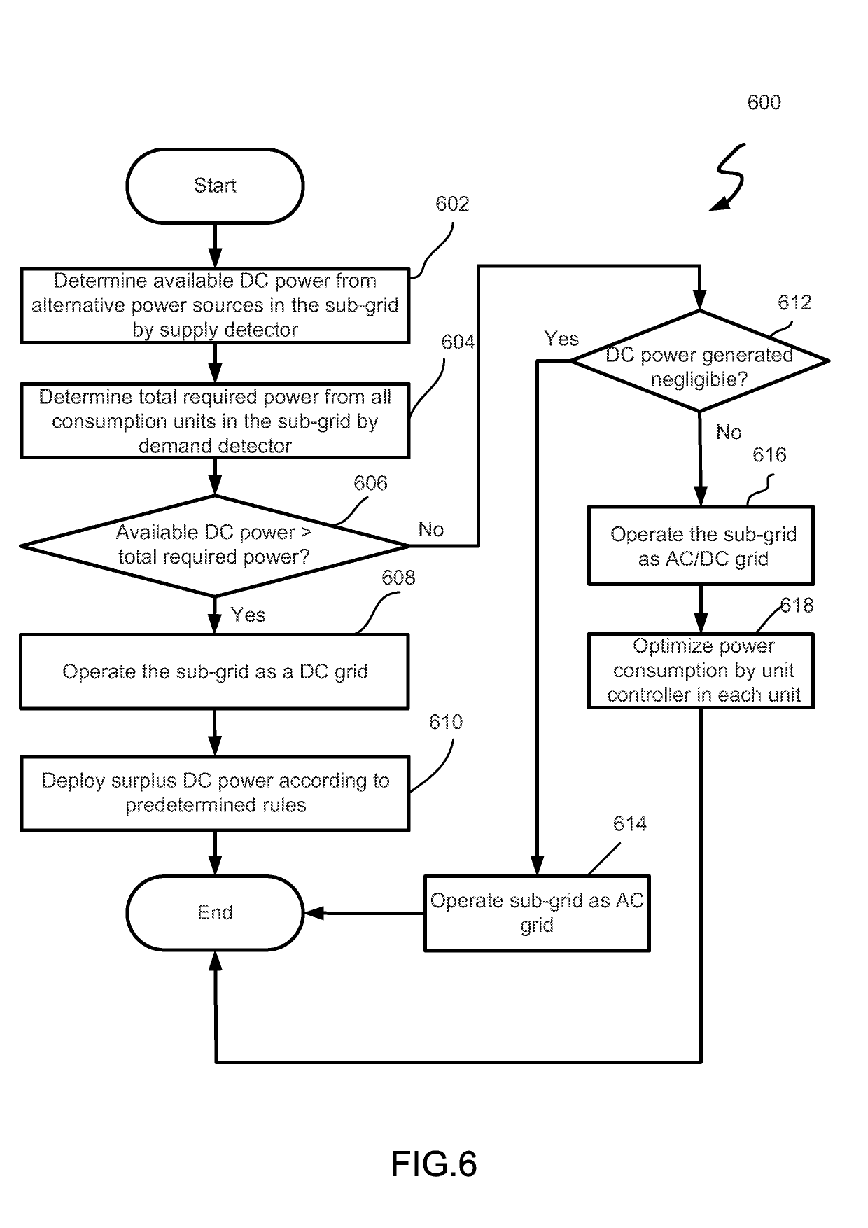

FIG. 6 is a flowchart illustrating a process of selecting one of the operation modes of the sub-grid 106. Process 600 begins with step 602 that available DC power generated from all alternative power sources coupled to sub-grid 106 is determined by supply detector 126 of sub-grid controller 114. Subsequently, or concurrently, required power from all consumption units coupled to sub-grid 106 is determined by demand detector 124 in step 604. Decision 606 decides if the available DC power is more than required DC power. If decision 606 decides that available DC power is more than required DC power, sub-grid controller 114 selects the operation mode of sub-grid 106 to distribute DC power only in step 608. DC power is distributed by DC power distribution unit 110 to consumption units 134. Surplus DC power is deployed in step 610 according to predetermined rules. The surplus DC power may be converted into AC power and be injected into AC power grid 102. The surplus DC power may also be stored in grid storage unit 128. The surplus DC power may even be transferred to another sub-grid through inter sub-grid power bridge 132.

If decision 606 decides that available DC power is less than required DC power, another decision 612 decides if DC power generated is negligible. If decision 612 decides that the DC power is negligible, sub-grid controller 114 selects to operate sub-grid to distribute AC power received from AC power grid 102 only in step 614. If decision 612 decides that DC power generated is not negligible, sub-grid controller 114 selects sub-grid 106 to distribute both AC and DC powers through AC power distribution unit 108 and DC power distribution unit 110, respectively in step 616. AC power is drawn from AC power grid 102. Each of the unit controllers (146) optimizes power consumption by consuming DC power as a priority in step 618 for each of the consumption units.

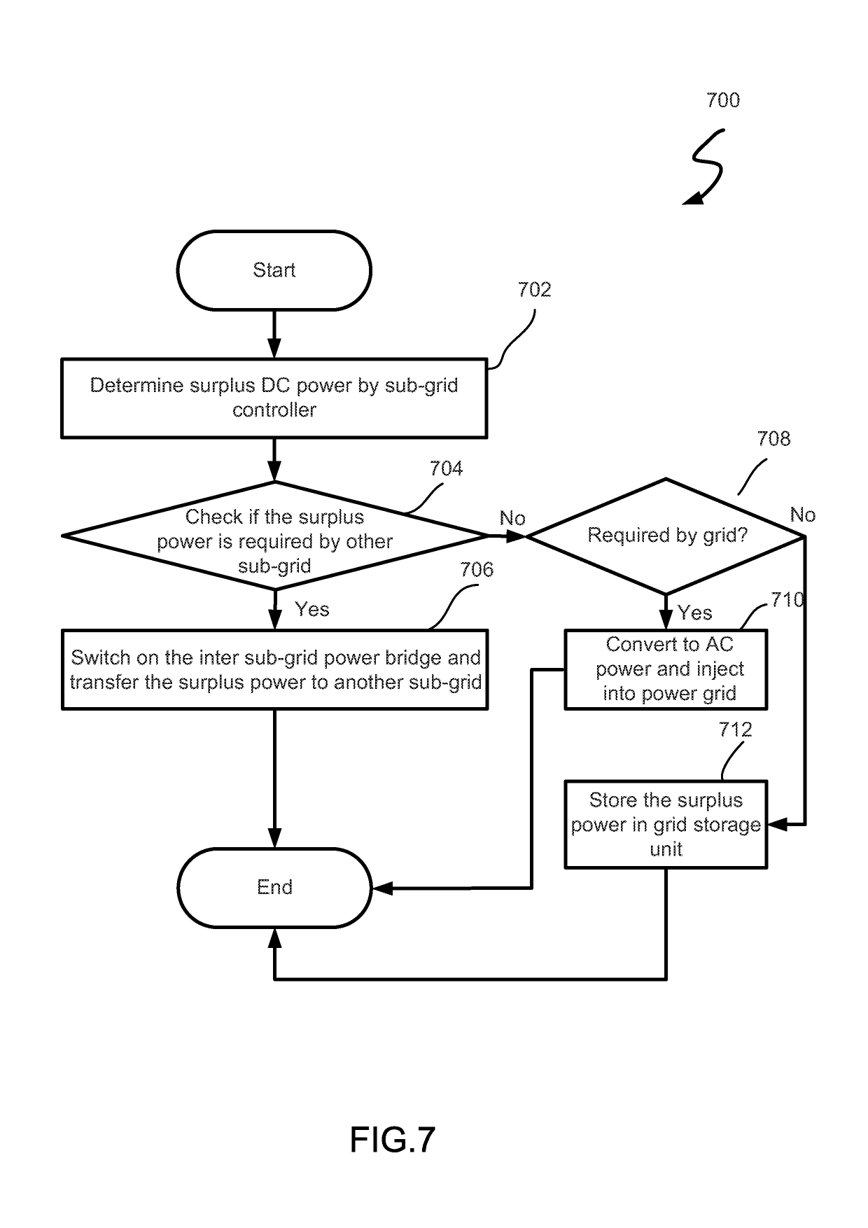

FIG. 7 is a flowchart illustrating a process of deploying surplus DC power generated from alternative power sources coupled to the sub-grid. Process 700 begins with step 702 that surplus DC power generated from the alternative power sources is determined after deducting required DC power from all consumption units from the available DC power. Decision 704 decides if surplus DC power is required by another sub-grid. If decision 704 decides that surplus DC power is required by another sub-grid, inter sub-grid power bridge 132 is switched on to transfer the surplus DC power to another sub-grid in step 706. If decision 704 decides that surplus DC power is not required by another sub-grid, decision 708 decides if the DC power is required by AC power grid 102. If decision 708 decides that DC power is required by AC power grid 102, DC power is converted into AC power and is injected to AC power grid in step 710. If decision 708 decides that AC power grid 102 does not require the surplus DC power, the surplus DC power is stored in grid storage unit 128 in step 712.

While the invention has been disclosed with respect to a limited number of embodiments, numerous modifications and variations will be appreciated by those skilled in the art. Additionally, although the invention has been described particularly with respect to sub-grid, it should be understood that the inventive concepts disclosed herein are also generally applicable to higher or lower level grids. The inventive concepts are also applicable to other power distribution systems such as micro-grids. Although three operation modes are disclosed exemplary in the embodiments, it should be understood that the inventive concepts disclosed herein are also generally applicable to more or less operation modes. For example, the exemplary system disclosed herein may be simplified to include anyone of two operation modes only. The exemplary system may even include alternative power sources that generate AC power. It is intended that all such variations and modifications fall within the scope of the following claims:

1. A power sub-grid for distributing electrical power to a plurality of consumption units coupled to the sub-grid, the sub-grid comprising:
(a) an AC power distribution unit for distributing AC power received from an AC power grid to the consumption units;
(b) a DC power distribution unit for distributing DC power generated at least from one alternative power source to the consumption units;
(c) a controller for selecting one of the following operation modes for the sub-grid:
a. distributing AC power only;
b. distributing DC power only; and
c. distributing both AC and DC powers.

2. The sub-grid as recited in claim 1, wherein said sub-grid is coupled to the AC power grid through a switch, wherein said switch is controlled by said controller.

3. The sub-grid as recited in claim 1, wherein said controller further comprises a processor;

4. The sub-grid as recited in claim 1, wherein said controller further comprises a supply detector pertaining to determining available DC power generated by said alternative power source.

5. The sub-grid as recited in claim 1, wherein said controller further comprises a demand detector pertaining to determining power required from the consumption units.

6. The sub-grid as recited in claim 1, wherein said controller further comprises a converter for converting DC power into AC power;

7. The sub-grid as recited in claim 1, wherein said controller further comprises a grid storage unit.

8. The sub-grid as recited in claim 1, wherein each of said consumption units further comprises a unit controller, wherein said unit controller further provides a means of connecting the unit to the AC distribution unit or to the DC distribution unit or to both AC and DC distribution units in accordance with said operation mode of said sub-grid.

9. The sub-grid as recited in claim 1, wherein said sub-grid further comprises an inter sub-grid power bridge, wherein said power bridge is connectable to another sub-grid, wherein said power bridge provides a means of delivering surplus DC power from the sub-grid to said another sub-grid.

10. The sub-grid as recited in claim 9, wherein said power bridge is controlled by said controller.

11. The sub-grid as recited in claim 1, wherein said controller further comprises a communication unit for communicating with another communication unit in another sub-grid.

12. The sub-grid as recited in claim 1, wherein said alternative power source further comprising a power source from one or a combination of the following:
(a) a solar power system;
(b) a wind turbine; and
(c) a fuel cell system.

13. A method of distributing electrical power to a plurality of consumption units through a power sub-grid, the method comprising selecting one of the following operation modes for the sub-grid by a controller:
(a) distributing only AC power through an AC power distribution unit;
(b) distributing only DC power through a DC power distribution unit; and
(c) distributing both AC and DC powers through the AC and the DC power distribution units, respectively.

14. The method as recited in claim 13, wherein said method further comprises determining available DC power by a supply detector of said controller.

15. The method as recited in claim 13, wherein said method further comprises determining required power from the consumption units by a demand detector in said controller.

16. The method as recited in claim 13, wherein said method further comprises supplying surplus DC power generated by one or a plurality of alternative power sources to another sub-grid through an inter sub-grid power bridge.

17. The method as recited in claim 13, wherein said method further comprises converting surplus DC power generated by one or a plurality of alternative power sources into AC power and injecting the AC power into an AC power grid.

18. The method as recited in claim 13, wherein said method further comprises storing surplus DC power generated by one or a plurality of alternative power sources into a grid power storage unit.

19. A control device for a power consumption unit coupled to a power sub-grid, wherein said consumption unit includes appliances that receive AC power and appliances that receive DC power, the device comprises:
(a) a processor;
(b) a demand detector pertaining to determining required electrical power for powering the electrical appliances in the unit;
(c) a supply detector pertaining to determining available DC power from a DC distribution unit of the sub-grid;
(d) a means of consuming said available DC power as a priority over consuming the AC power.

20. The control device as recited in claim 19, wherein said control device is coupled to a first switch and a second switch, wherein said first connects the unit to a AC power distribution unit of the sub-grid and said second switch connects the unit to the DC power distribution unit.
